(19) United States
(12) Patent Application Publication
(10) Pub. No.: US 2016/0216558 A1
(43) Pub. Date: Jul. 28, 2016

(54) STRENGTHENED GLASS SUBSTRATES FOR POLARIZERS AND COLOR FILTERS

(71) Applicant: EMPIRE TECHNOLOGY DEVELOPMENT LLC, Wilimington (DE)

(72) Inventors: Motoyuki Toki, Kyoto (JP); Masumi Honda, Kyoto (JP)

(73) Assignee: Empire Technology Development LLC, Wilmington, DE (US)

(21) Appl. No.: 14/916,573

(22) PCT Filed: Sep. 9, 2013
(86) PCT No.: PCT/US2013/058808

§ 371 Date: Mar. 4, 2016

(51) Int. Cl. G02F 1/1335; G02B 5/22; G02B 5/30; G02B 5/20

(52) U.S. Cl. CPC G02F 1/133533; G02B 5/201; G02B 5/223; G02B 5/3058; G02B 5/305; G02F 1/133514; G02F 1/133512; G02F 2001/133548

(57) ABSTRACT

A strengthened glass substrate can include a polysiloxane film on at least one surface of the glass substrate. The polysiloxane film can be under internal compressive stress. such that the fracture strength of the glass substrate may be improved. The polysiloxane film can be a color-filtering polysiloxane film, a polarizing polysiloxane film or both.

### BACKGROUND

Smartphones, tablet PCs, and devices with liquid crystal displays (LCDs) have recently formed large markets, become popular types (if mobile terminals, and dramatically changed the lifestyles of users. However, there remains a need to reduce the weight of these devices. Conventional LCDs are constructed from a large number of components, such as glass substrates, a polarizer, a color filter, a transparent conductive film, thin-film transistors, an alignment layer, and a liquid crystal layer. Therefore, it is difficult to reduce the weight of the LCD device and the cost, time, and complexity of the manufacturing process.

### SUMMARY

In some embodiments, a color filter can include a glass substrate including a top surface and a bottom surface. The glass substrate can have a thickness of about 100 μm or less. The color filter can also include a color-filtering polysiloxane film formed on the top surface of the glass substrate. The color-filtering polysiloxane film can include a black matrix defining a pattern of openings and a plurality of colored inks disposed separately within the openings in the black matrix. The black matrix and the plurality of colored inks can include pigments dispersed in polysiloxane. The color-filtering polysiloxane film can be under internal compressive stress, thereby improving a fracture strength of the glass substrate.

In some embodiments, a method of making a color filter can include: providing a glass substrate having at thickness of about 100 μm or less; forming a black matrix on a top surface of the glass substrate, wherein the black matrix is formed from a black ink; forming a color filter to the top surface of the glass substrate, wherein the color filter is formed from a plurality of different colored inks; and treating the substrate under conditions sufficient to cause partial oxidation of the polysilane in the ink base, thereby generating internal compressive stress as the polysilane is partially oxidized such that a volume of the ink base is expanded and a fracture strength of the glass substrate is improved. Each colored ink can be disposed m a subset of a pattern of openings defined by the black matrix on the top surface. Each colored ink can be disposed separately by the black matrix from the other colored inks. The black ink and the plurality of different colored inks can include different colored pigments dispersed in an ink base that includes polysilane.

In some embodiments, a color filter substrate can be formed by a process that includes; depositing a black matrix on a top surface of a glass substrate, the black matrix forming a pattern of openings, wherein the black matrix comprises a black pigment dispersed in a polysilane ink base; depositing a plurality of different colored inks into the openings; and treating the substrate under conditions sufficient to cause partial oxidation of polysilane in the ink, base, thereby generating compressive stress as the polysilane is partially oxidized and improving a fracture strength of the glass substrate. Each colored ink can be deposited to a subset of the pattern of openings defined by the black matrix, such that when deposited, each colored ink is separated by the black matrix from the other colored inks. The plurality of different colored inks can include different colored pigments dispersed in an ink base that includes polysilane.

In some embodiments, a polarizer can include; a glass substrate having a thickness of about 100 μm or less; and a polarizing polysiloxane film formed on a top surface of the glass substrate. The polarizing polysiloxane film can be in the form of a wire grid pattern defined by a plurality of parallel projections and recesses, the wire grid pattern being configured to polarize light. The polarizing polysiloxane film can be under internal compressive stress, thereby improving as fracture strength of the glass substrate.

In some embodiments, a method of making a polarizer can include; providing as glass substrate having a thickness of about 100 μm or less; forming a top film having polysilane on a top surface of the glass substrate; forming a plurality of projections and recesses on the top film; and after forming the plurality of projections and recesses on the top film, treating the substrate under conditions sufficient to cause partial oxidation of the top film, thereby generating compressive stress as the top film is partially oxidized such that a volume of the top film is expanded and a fracture strength of the glass substrate is improved. The plurality of projections and recesses can extend parallel to each other and define a wire grid pattern configured to polarize light.

In some embodiments, a polarizer can be formed by a process that includes: depositing a top polysilane film on a top surface of a glass substrate having a thickness of about 100 μm or less; forming a wire grid pattern on the top polysilane film, the wire grid pattern having a plurality of parallel projections and recesses; and treating the substrate under conditions sufficient to cause partial oxidation of the top polysilane

In some embodiments, a glass substrate with an integrated color filter and polarizer can include; the glass substrate including a top surface and a bottom surface and having a thickness of about 100 μm or less; a color-filtering polysiloxane film formed on the top surface; and a polarizing polysiloxane film formed on the bottom surface of the glass substrate. The color-filtering polysiloxane film can include; a black matrix defining, a pattern of openings; and a plurality of colored inks disposed separately within the openings in the black matrix. The black matrix, and the plurality of colored inks can including pigments dispersed in polysiloxane. The color-filtering polysiloxane film can be under internal compressive stress, thereby improving a fracture strength of the glass substrate. The polarizing polysiloxane film can be in the form of a wire grid pattern defined by as plurality of parallel projections and recesses, the wire grid pattern being configured to polarize light. The polarizing polysiloxane film can be under internal compressive stress, thereby improving a fracture strength of the glass substrate.

In some embodiments, a liquid crystal display can include; a color filter; a polarizer; and a liquid crystal layer disposed between the color filter and the polarizer. The color filter can include; a color-filtering polysiloxane film formed on as top surface of a first glass substrate; and a bottom polysiloxane film formed on a bottom surface of the first ultra-thin glass substrate. The color-filtering polysiloxane film can include: as black matrix defining a pattern of openings; and a plurality of colored inks disposed separately within the openings in the black matrix. The black matrix and the plurality of colored inks can include pigments dispersed in polysiloxane. The polarizer cart include a polarizing polysiloxane film formed on a top surface of a second glass substrate. The polarizing polysiloxane film can include a wire grid pattern defined by a plurality of parallel projections and recesses configured to polarize light. The liquid crystal layer can be disposed between the top surface of the first glass substrate and the bottom surface of the second glass substrate.

A device having a liquid crystal display can include: a color filter; a polarizer, and a liquid crystal layer disposed between the color filter and the polarizer. The color filter can include: a color-filtering polysiloxane film formed on a top surface of a first glass substrate; and a bottom polysiloxane film formed on a bottom surface of the first glass substrate The color-filtering polysiloxane film can include: a black matrix defining a pattern of openings; and a plurality of colored inks disposed separately within the openings in the black matrix, The black matrix and the plurality of colored inks can include pigments dispersed in polysiloxane. The polarizer can include a polarizing polysiloxane film formed on a top surface of a second glass substrate. The polarizing polysiloxane film can include a wire grid pattern defined by a plurality of parallel projections and recesses configured to polarize light.

In some embodiments, a liquid crystal display can include: a first glass substrate; a second glass substrate; and a liquid a liquid crystal layer disposed between the interior surface of the first glass substrate and the interior surface of the second glass substrate. The first glass substrate can include: a first polarizing polysiloxane film formed on an exterior surface of the first glass substrate; and as color-filtering polysiloxane film formed on an interior surface of the first glass substrate. The first polarizing polysiloxane film can include a first wire grid pattern defined by a first plurality of parallel projections and recesses configured to polarize light. The color-filtering polysiloxane film can include: to black matrix defining a pattern of openings; and a plurality of colored inks disposed separately within the openings in the black matrix, wherein the black matrix and the plurality of colored inks comprise pigments dispersed in polysiloxane. The second glass substrate can include: a second polarizing polysiloxane film formed on an exterior surface of the second glass substrate. The second polarizing polysiloxane film can include a second wire grid pattern defined by a second plurality of parallel projections and recesses configured to polarize light.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing, and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 illustrates a cross-sectional view of a strengthened ultra-thin glass substrate with a color-filtering polysiloxane film formed on one side of the glass substrate and a film of polysiloxane formed on the other side of the glass substrate.

FIG. 2 illustrates a top view of a color-filtering, polysiloxane film.

FIG. 3 illustrates a cross-sectional view of a strengthened ultra-thin glass substrate with a polarizing polysiloxane film formed on one side of a glass substrate and a film of poly formed on the other side of the glass substrate.

FIG. 4 illustrates a perspective view of a polarizing polysiloxane film.

FIG. 5 illustrates a strengthened ultra-thin glass substrate with a color-filtering polysiloxane film formed on one side of a glass substrate and a polarizing polysiloxane film formed on the other side of the glass substrate.

FIG. 6 illustrates a LCD device using two strengthened ultra-thin glass substrates, one substrate with a polarizing polysiloxane film formed thereon, and the other substrate with a polarizing polysiloxane film as well as a color-filtering polysiloxane film formed thereon.

FIG. 7 illustrates a method of making a strengthened ultra-thin glass substrate with a color filter.

FIG. 8 illustrates a method of making a strengthened ultra-thin glass substrate with a polarizer.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

In order to reduce the weight, costs, and complexity of LCD devices multiple components can be integrated with an ultra-thin glass substrate for example. in-cell structures can be employed). However, the ultra-thin glass substrate can often be susceptible to cracking. Thus, in some embodiments, multiple components can be integrated in a manner that helps prevent the glass substrate from cracking. For example, the ultra-thin glass substrate can be strengthened against external forces such as bending stresses and dropping impacts. In some embodiments, color filters can be formed on an ultra-thin glass substrate. Similarly, polarizers can be formed on an ultra-thin glass substrate. In addition, a polysiloxane film can be formed on the ultra-thin glass substrate to improve the fracture strength of the glass substrate. Furthermore, the polarizer and color filter can impart compressive stress onto the ultra-thin glass substrate, thereby strengthening the glass substrate and preventing it from cracking.

In order to generate internal compressive stress, a polysilane composition can be used to make the color filter, polarizer, and polysiloxane film on a glass substrate. For example, polysilane can serve as the ink base for a color filter. In some embodiments, internal compressive stress can be generated by treating the polysilane composition under proper conditions such that the polysilane composition expands in volume. For example, when a polysilane composition is heated in air (for example, at 220° C.), internal compressive stress can be created as the polysilane composition can expand in volume. By using a polysilane composition in as color filter, polarizer, and polysiloxane film on a glass substrate, internal compressive stress can be imparted onto the glass substrate, thereby improving the fracture strength of the glass.

In addition, treating the polysilane composition can cause a reaction converting polysilane into a different compound. For example, heating polysilane can convert it into polysiloxane. In some embodiments, these reactions can generate internal compressive stress because the products (for example, polysiloxane of the chemical reaction are larger in volume than that of the reactants (for example, polysilane). Accordingly, in sonic embodiments, the material of the color filter, polarizer, and polysiloxane film formed on the glass substrate may include polysiloxane, which cart be obtained by treating a polysilane composition under conditions sufficient to cause volume expansion.

In some embodiments, a polarizing polysiloxane film is formed on one side of the ultra-thin glass substrate and a color filtering polysiloxane film is formed on the other side of the glass substrate. In other embodiments, the polarizing polysiloxane film is formed on a first glass substrate, and a color filtering polysilane film is formed on a second glass substrate. In other embodiments, a polarizer or a color filtering polysilane is formed on one side of a glass substrate, and a polysiloxane film is formed on the other side of the glass substrate. Thus, some embodiments include as strengthened ultra-thin glass substrate with an integrated color filter and/or polarizer. In some embodiments, the strengthened ultra-thin glass substrate with an integrated color filter and/or polarizer can be used with LCD devices.

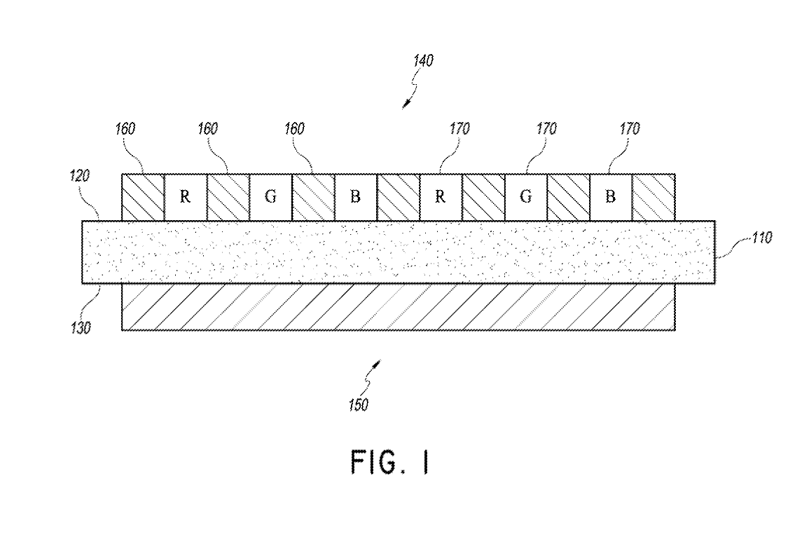

FIG. 1 illustrates a cross-sectional view of an in-cell structure including a color-filtering polysiloxane film 140 formed onto the top surface 120 of the glass substrate 110 and a film of polysiloxane 150 formed onto the bottom surface 130 of the glass substrate 110. In some embodiments, the color-filtering polysiloxane film 140 and the bottom polysiloxane film 150 are under internal compressive stress, thereby imparting, compressive stress on the glass substrate and improving the fracture strength of the glass substrate 110. Thus, the color-filtering polysiloxane film 140 serves to both filter color from a LCD device and also to strengthen the ultra-thin glass substrate 110 against external forces such as bending or dropping impacts.

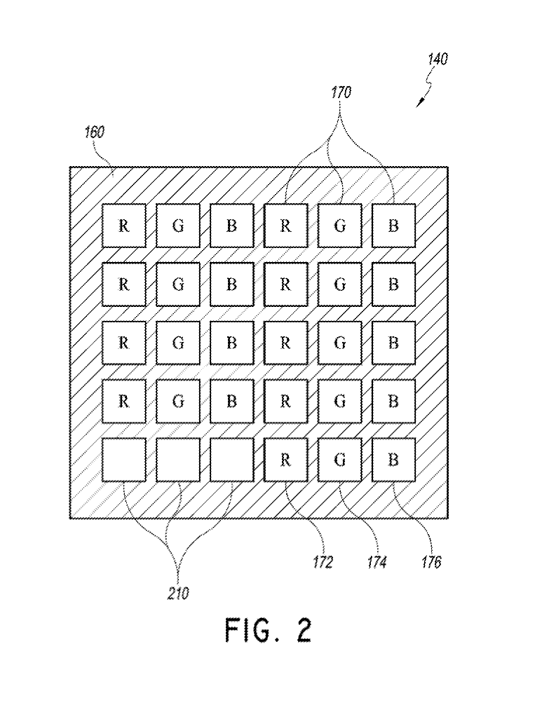

A top view of the color-filtering polysiloxane film 140 is illustrated in FIG. 2, In some embodiments, the color-filtering polysiloxane film 140 includes a black matrix 160 and a plurality of different colored inks 170 disposed separately between the openings 210 in the black matrix 160. For illustrative purposes, FIG. 2 illustrates openings 210 in the black matrix 160 without colored inks 170. The black matrix 160 and the plurality of different colored inks 170 can be formed from an ink, including pigments dispersed in a polysilane ink base. When treated, polysilane in the ink base can expand in volume and be converted to polysiloxane. Thus, referring to FIG. 2, both the black matrix 160 and the plurality of different colored inks 170 can include pigments dispersed in polysiloxane, which can be obtained by treating pigments dispersed in polysilane. Further, both the black matrix 160 and different colored inks 170 can be under internal compressive stress, such that the fracture strength of the glass is improved.

A variety of combinations of pigments can be used to prepare the different colored inks 170. For example, some combination of a red, green, blue, yellow, orange. violet, and a black pigment can be used Furthermore, the pigments cart include quinacridone-based pigments, anthraquitione-based pigments, diketopyrrolopyrrole pigments, perylene-based pigments, phthalocyanine-blue-based pigments, phthalocyanine-green-based pigments, isoindolinone-based pigments, indigo/thioindigo pigments, dioxazine-based pigments, quinoplithalone pigments, nickel azo pigments, insoluble-aw-based pigments, soluble-azo-based pigments., high-molecular-mass azo-based pigments, carbon black pigments, complex-oxide-based black pigments, iron-oxide black. pigments, titanium-oxide-based black pigments, and azomethine-azo-based black pigments. The pigments can be organic, inorganic, or a combination thereof.

In some embodiments, the plurality of different colored inks 170 include their respective colored pigment dispersed in an ink base including polysilane. For example, a red colored ink can include a red color pigment, such as C.I. Pigment Red (PR) 19, 23, 29, 30, 37, 40, 56, 58, 122, 166, 168, 176, 177, 178, 224, 242, 254, or 255, dispersed in a polysilane ink base. Similarly, a green colored ink can include a green color pigment, such as C.I. Pigment Green (PG) or 7, 36, 58, poly (14-16) brominated copper phthaloeyanine, or poly (12-15) brominated-poly (4 It chlorinated copper phthalocyanine. Similarly, a blue colored ink can include a blue color pigment, such as Pigment Blue (PB) 15, 15:1, 15:3, 15:4, 15:6, 60, or 80. In some embodiments, a complementary yellow or violet pigment can be added to the colored inks 170. The yellow pigment can include Pigment Yellow (PY) 12, 13, 14, 17, 24, 55, 60, 74, 83, 90, 93, 126, 128, 138, 139, 150, 154, 155, 180, 185, 216, or 219. The violet pigment can include Pigment Violet (PV) 19 or 23. The black matrix 160 can be formed from an ink base including polysilane and a black pigment. For example, the black pigment can include color index (C.I.) Pigment Black (Pbk) 6, 7, 11, 26, or a copper-manganese-iron-based complex oxide.

Referring to FIG. 2, in some embodiments, the plurality of different colored inks 170 includes a red ink 172, a green ink 174, and a blue ink 176, disposed on the substrate in a Green Blue Red (GBR) three-color pattern. Other color patterns are possible.

Returning to FIG. 1, the color-filtering polysiloxane film 140 integrated onto the glass substrate 110 can form an in-cell structure and reduce the weight of LCD devices. The weight of LCD devices can also be reduced due to the thinness of the glass substrate 110, color-filtering polysiloxane film 140, and the bottom polysiloxane film 150. Generally, there is often a trade-off between thickness and weight of the LCD device, Thus, it is often desirable to users for the glass substrate 110 to be as thin as possible. In some embodiments, the ultra-thin glass substrate 110 can have a thickness of about 100 μm or less. For example, the thickness of the glass substrate 110 can be about 10 μm, about 15 μm, about 20 μm about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm or a thickness between any of these values. In some embodiments, the thickness of the glass substrate is about 30 μm.

In some embodiments, the thickness of the color-filtering polysiloxane film 140 can be about 100 nm to about 5 μm. For example, the thickness can be about 100 nm, about 200 nm, about 300 nm, about 400 nm, about 500 nm, about 600 nm, about 700 nm, about 800 nm, about 900 nm, about 1 μm, about 2 μm, about 3 μm, about 4 μm, about 5 μm or a thickness in between any of these values, in some embodiments, the thickness of the color-filtering polysiloxane film is about 100 nm.

In some embodiments, the thickness of the bottom polysiloxane film 150 can be about 5 μm to about 30 μm. For example, the thickness can be about 5 μm, about 10 μm, about 15 μm, about 20 μm, about 25 μm, about 30 μm or a thickness between any of these values. The thickness of the bottom polysiloxane film can be about 20 μm according to some embodiments.

Although the glass substrate 110 can be ultra-thin, the glass substrate can have an improved fracture strength because the color-filtering polysiloxane film 140 and the bottom polysiloxane film 150 can impart compressive strength onto the glass substrate 110.

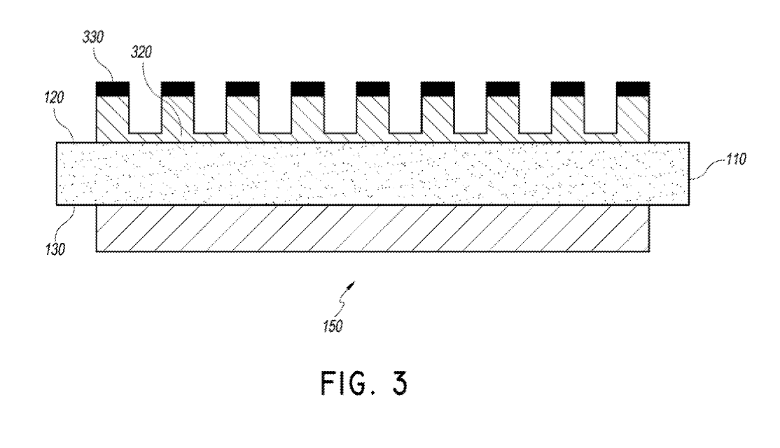

FIG. 3 illustrates a cross sectional view of an in-cell structure including a polarizing polysiloxane film 320 formed on the top surface 120 of an ultra-thin glass substrate 110. In some embodiments, a metallic thin film 330 coating may be formed on the polarizing polysiloxane film 320. In some embodiments, the polarizing polysiloxane film 320 can be about 20 μm to about 100 μm thick. For example, the thickness of the polarizing polysiloxane film 320 can be about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 run, or a thickness between any of these values. The thickness of the metallic film 330 can be about 20 nm to about 50 nm. For example, the thickness of the metallic film can be about 20 nm, about 25 nm, about 30 nm, about 35 nm, about 40 nm, about 45 nm, about 50 nm, or a thickness between any of these values. In some embodiments, the metallic thin film 330 coats a portion of the polarizing polysiloxane film 320. The polarizing polysiloxane film 320 can be under internal compressive stress, such that compressive stress is imparted onto the glass substrate 110 and the fracture strength of the glass substrate 110 is improved. Still referring to FIG. 3, the glass substrate 110 can also include a film of polysiloxane 150 formed on the bottom surface 130 of the glass substrate 110. The bottom polysiloxane film 150 can be under internal compressive stress in order to further increase the fracture strength of the glass substrate 110.

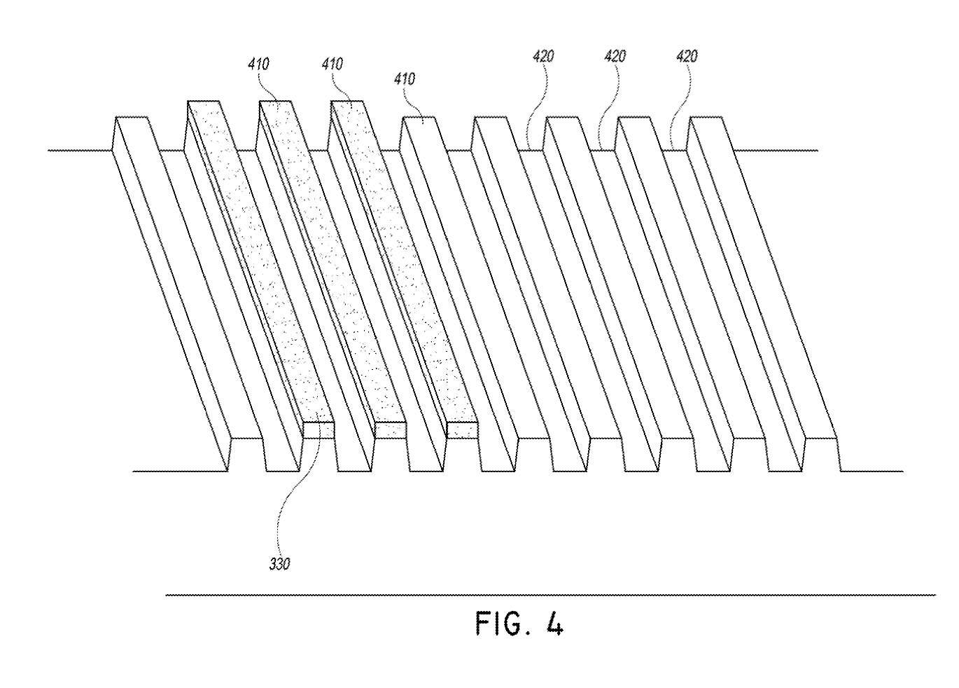

FIG. 4 illustrates a perspective view of a polarizing polysiloxane film 320. Referring to FIG. 4, the polarizing polysiloxane film 320 includes a plurality of parallel projections 410 and recesses 420, which define a wire grid pattern. In some embodiments, the projections are about 100 nm high and about 100 nm wide. In addition, the recesses are about 100 run wide in some embodiments. In some embodiments, the polarizing polysiloxane film 320 further includes stripes of metallic thin film 330 coating the projections 410 in the wire grid pattern. The wire grid pattern and the metallic thin film 330 can create a functional polarizer. Thus, the polarizing polysiloxane film 320 integrated on the ultra-thin glass substrate 110 can serve to both polarize light from a LCD device and also to strengthen the glass substrate 110 by imparting compressive stress onto the glass substrate 110.

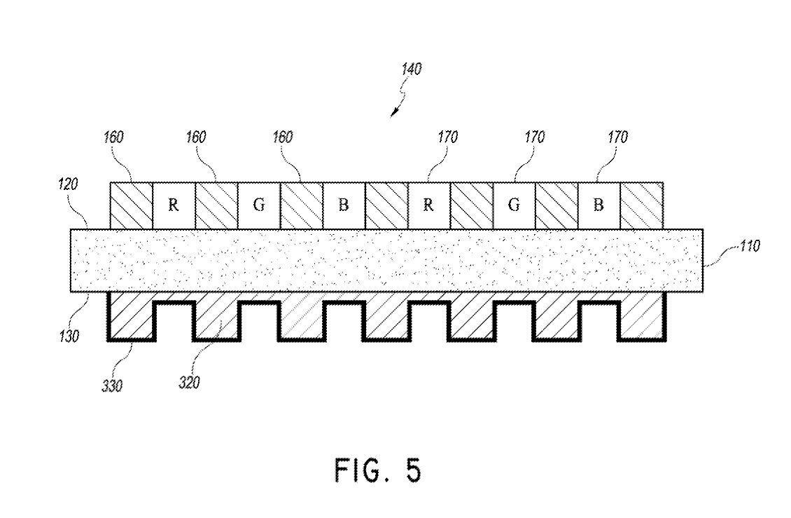

The embodiments shown in FIG. 1 and FIG. 3 illustrate a color-filtering polysiloxane film 140 and a polarizing polysiloxane film 320, respectively, with a polysiloxane film 150 on the bottom surface of the glass substrate 110. In other embodiments, the glass substrate 110 lacks a polysiloxane film 150 on the bottom surface. For example, in some embodiments, a glass substrate 150 can include a color-filtering polysiloxane film 140 or a polarizing polysiloxane film 320 on the top surface 120 of the glass substrate 110 and lack polysiloxane film 150 on the bottom surface. Other embodiments can include a polysiloxane film 150 on one side of the glass substrate 110, and a color-filtering polysiloxane film 140 or a polarizing polysiloxane film 320 on the other side of the glass substrate 110. In some embodiments, one glass substrate 110 can include a color-filtering polysiloxane film 150 on one side of the glass substrate 110, and a polarizing polysiloxane film 320 on the other side of the glass substrate 110, as illustrated in FIG. 5. For example, FIG. 5 illustrates an ultra-thin glass substrate 110 with a color-filtering polysiloxane film 140 formed on the top surface 120 of the glass substrate and a polarizing polysiloxane film 320 formed on the bottom surface 130 of the glass substrate 110.

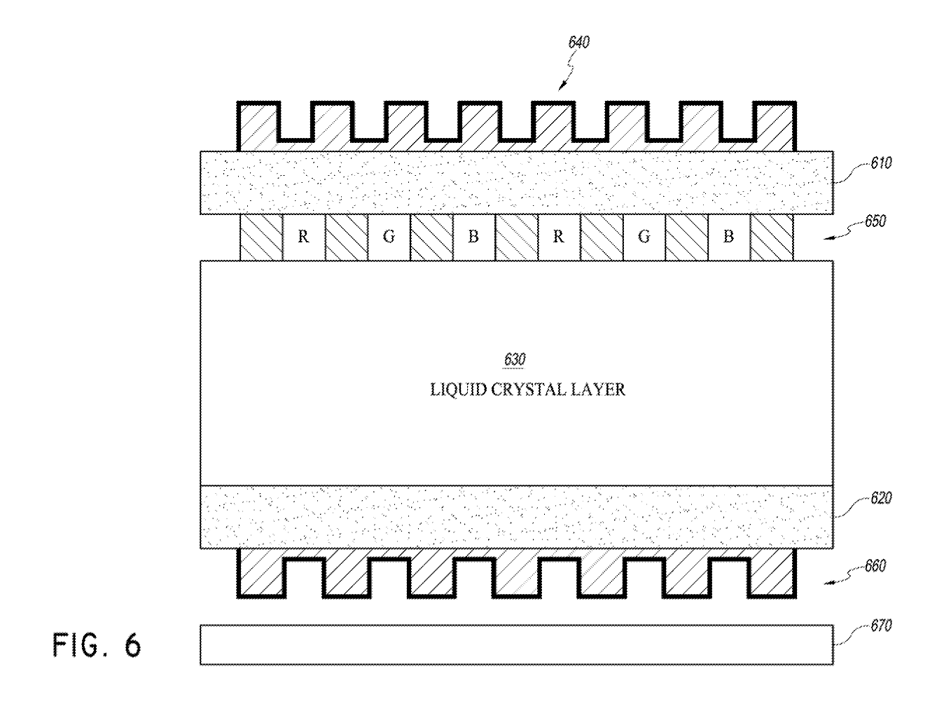

FIG. 6 illustrates an embodiment of a tablet PC LCD device having an in-cell structure and using ultra-thin strengthened glass substrates, The ultra-thin glass substrates can have a color-filtering polysiloxane film and/or a polarizing polysiloxane film formed thereon according to some embodiments. Referring to FIG. 6, a tablet PC LCD device can include a first substrate 610, a second substrate 620, a liquid crystal layer 630 therebetween, and a backlight: unit 670. The first substrate 610 can include a polarizing polysiloxane film 640 on one side and a color-filtering polysiloxane film 650 on the other side of the substrate 610. in sonic embodiments, the polarizing polysiloxane film 640 can be formed on the exterior surface of the first substrate 610, for example, the side of the substrate that faces away from the liquid crystal layer 630, in addition, the color-filtering polysiloxane film 650 can be formed on the interior surface of the first substrate 610, for example, the side of the first substrate 610 facing toward the liquid crystal layer 630. Still referring to FIG. 6, the second substrate 620 can include an integrated polarizing polysiloxane film 640 on the exterior surface of the substrate 630. By forming a color filter and polarizer on an ultra-thin glass substrate, the weight of tablet PC LCD devices can be dramatically reduced. At the same time, the ultra-thin glass substrate can have an improved fracture strength because the color filter and polarizer can be under internal compressive stress.

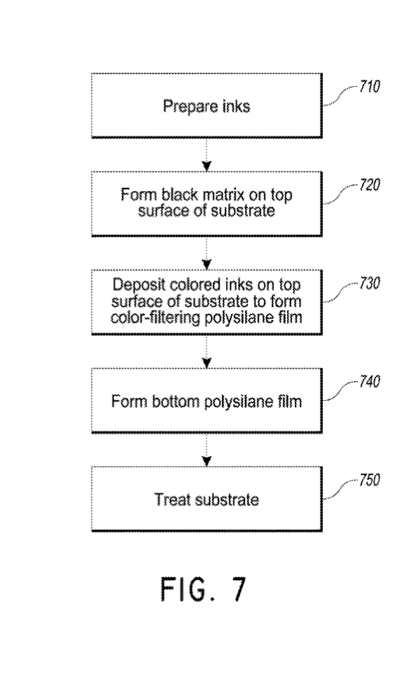

FIG. 7 illustrates a method of making a strengthened ultra-thin glass substrate with a color filter. At step 710, ink for the color filter 140 can be prepared. This ink can be prepared by dispersing one or more pigments in an ink base including polysilane. For example, a red ink, a blue ink, a green ink, and a black ink can be prepared, with the pigments described above with respect to FIG. 2. At step 720, a black matrix can be formed on a top surface 120 of the glass substrate. In some embodiments, the black matrix 160 can be formed by depositing a black ink prepared in step 71.0 onto the glass substrate 110 by ink-jet printing. In other embodiments, the black matrix 160 can be formed by photolithography or any other suitable method. The black matrix 160 can define a plurality of openings 210 configured to receive different colored inks, as illustrated in FIG. 2.

Returning to FIG. 7, at step 730, different colored inks can be deposited onto the top surface of the glass substrate 110 in order to firm a color-filtering polysilane film. In sonic embodiments, the color-filtering polysilane film can be formed by ink-jet printing. In some embodiments, a red ink prepared in step 710 is deposited into a subset of the openings 210 in the black matrix 160, at green in prepared in step 710 is deposited into another subset of openings 210, and a blue ink prepared in step 710 is deposited into yet another subset of openings 210, such that the colored inks form a GBR three-color pattern. In other embodiments, the color-filtering polysilane film 140 can be formed by photolithography, screen printing, or any other suitable method.

At step 740, a film of polysilane 150 can be farmed on the bottom surface 130 of the glass substrate 110. The bottom polysilane film 150 can be formed by coating, spin-coating, dipping, or any other suitable method known in the art. In some embodiments, a method of forming the bottom polysilane film 150 can include preparing a solution, applying the solution to an ultra-thin glass substrate 110, and drying the solution to form a film of polysilane 150 on the glass substrate 120. In some embodiments, the solution can be prepared by dissolving polysilane in at least one organic solvent, such as toluene or tetrahydrofuran (THF). The solution can be dried by natural air-drying or by using a drying machine When the solution is dried by using a drying machine, the drying temperature can be about 70° C. to about 150° C. For example, the drying machine temperature can be about 100° C. to about 120 C according to some embodiments. By applying and drying the solution on the glass substrate 1.10, a bottom polysilane film 150 can be formed. As illustrated in to FIG. 7, the bottom polysilane film can be formed after forming the color-filtering polysilane film. However, in other embodiments, the bottom polysilane film can be formed before forming the color-filtering polysilane film. In addition, some embodiments can omit the step of forming the bottom polysilane film.

Next, at step 750, the color filter 140 and the polysilane film can be treated by heating the substrate 110 or illuminating the substrate with UV light. The color-filtering polysilane film and the bottom polysilane film can be treated at the same time. In other embodiments, the color-filtering polysilane film and the polysilane film are treated separately. For example, the color-filtering polysilane film can be treated first, then the bottom polysilane film 150 can be treated after the color-filtering polysilane film is treated.

When the substrate 110 is treated, the volume of the polysilane in the color-filtering polysilane film 140 and the bottom polysilane film can expand according to some embodiments. In particular, in some embodiments, treating the substrate 110 can cause partial oxidation of polysilane, thereby creating oxygen bonds in the polymer structure, converting polysilane to polysiloxane, and causing volume expansion. For example, in some embodiments the substrate 110 is heated at 220° C. in air containing oxygen (O₂) in order to cause volume expansion of polysilane and convert it into polysiloxane. The substrate 110 can also be heated at a temperature ranging from 200° C. to 350° C. in an atmosphere containing oxygen, nitrogen, and/or argon gas in order to convert polysilane into polysiloxane.

In some embodiments, the substrate is heated at temperatures of about 350° C. to about 450° C. In these embodiments, polysilane can be converted into polycarbosilane. Similar to the reaction converting polysilane to polysiloxane, converting polysilane to polycarbosilane can cause volume expansion and generate internal compressive stress. However, because the glass substrate tends to fracture when it is heated at higher temperatures, it may be preferable to heat the substrate at temperatures below 350° C., which yields polysilane instead of polycarbosilane according to some embodiments. Furthermore, the conversion of polysilane into polysiloxane may generate more internal compressive stress compared to the conversion of polysilane into polycarbosilane. For this reason also, it may be preferable to heat the substrate at temperatures below 350° C. so that polysilane can be converted into polysiloxane.

Still referring to FIG. 7, treating the substrate 110 at step 750 can lead to formation of a color-filtering film of polysiloxane 140 on one side of the substrate, and a film of polysiloxane 150 on the other side of the substrate 110, When the volume of the polysilane expands, internal compressive stress can be generated in the color-filtering polysiloxane film 140 and the bottom polysiloxane film 150. Specifically, for example, the polysilane in the black matrix in as well as the different colored inks of the color filter can expand in volume and generate compressive stress. Thus, the coin filtering polysiloxane film 140 can serve the dual function of filtering color from a LCD device and also improving: the fracture strength of the glass substrate. The bottom polysiloxane film 150 can serve to further improve the fracture strength of the glass substrate.

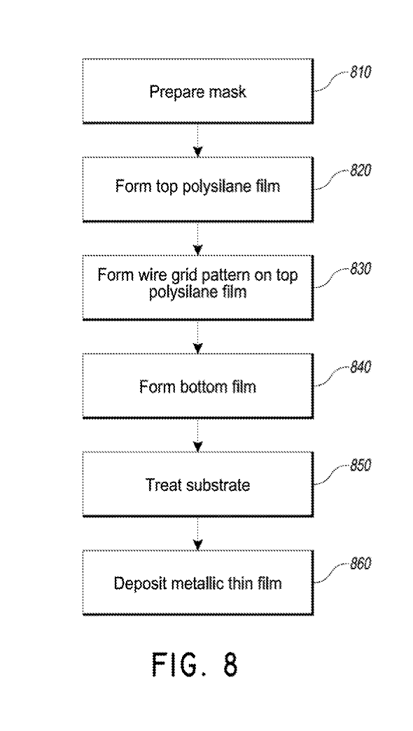

FIG. 8 illustrates a method of making an in-cell structure including a polarizing polysiloxane film 320 formed on an ultra-thin glass substrate 110. Referring to FIG. 8, at step 810, a nano-imprint mask can be prepared. In some embodiments, the nano imprint mask can be used to form projections 410 and recesses 420 on a polarizer 320. FIG. 4 illustrates an example of projections 410 and recesses 420 on a polarizer 320. The nano-imprint mask can be prepared according to a number of methods such as photolithography, etching, electron beam lithography, or any other suitable method. For example, a nano-imprint mask can be prepared by using photolithography to form a pattern of projections and recesses on the nano-imprint mask.

Next, at step 820, a film of polysilane can be formed on a top surface of a glass substrate 110 by any suitable method known in the art, such as coating, spin-coating, or dipping. In some embodiments, a method of forming a film of polysilane can include preparing a solution and applying the solution to an ultra-thin glass substrate 110, In some embodiments, the solution can be prepared by dissolving polysilane in at least one organic solvent, such as toluene or tetrahydrofuran (THF). Referring to step 830, while the top polysilane film is still wet, the nano-imprint mask can be used to nano-imprint a plurality of projections 410 and recesses 420 on the polarizing polysilane film, thereby forming a wire grid pattern.

Next, at step 840, a film of polysilane can be formed on the bottom surface of the glass substrate 110. As illustrated in FIG. 8, the bottom polysilane film 150 can be formed after forming the wire grid pattern on the top polysilane film. However, in other embodiments, the bottom polysilane film 150 can be formed before forming the wire grid pattern on the top polysilane film. In addition, some embodiments can omit the step of forming the bottom polysilane film. in some embodiments, a method of forming the bottom polysilane film 150 can include preparing a solution, applying the solution to an ultra-thin glass substrate 110, and drying the solution to form a ii hit of polysilane 150 on the glass substrate 120. In some embodiments, the solution can be prepared by dissolving polysilane in at least one Organic solvent, such as toluene or tetrahydroluran (THF). The solution can be dried by natural air-drying or by using a drying machine. By applying and drying the solution on the glass substrate 110, a bottom polysilane film 150 can be formed.

At step 850, the substrate 110 including the polarizing polysilane film and the bottom polysilane film 150 can be treated. As described above with respect to FIG. 7, treating the substrate can convert polysilane into polysiloxane, thereby creating, a polarizing polysiloxane film 320 and a bottom polysiloxane film 150 on the glass substrate 110. In addition, treating the substrate can cause volume expansion of the polysilane, thereby generating internal compressive stress and improving the fracture strength of the glass substrate 110. in some embodiments the substrate 110 is heated at 220° C. in air containing oxygen (O₂). The substrate 110 can also be heated at a temperature ranging from about 200° C. to about 350° C. in an atmosphere containing oxygen, nitrogen, and/or argon gas.

Next, at step 850, a layer of metallic thin film can be deposited onto the polarizing film of polysiloxane 320. In some embodiments, the metallic thin film coats a portion of the polarizing film of polysiloxane 320. For example, the metallic thin film can coat only the projections 410, thereby creating as metallic stripe pattern. The thickness of the metallic thin film can be controlled according to any suitable method known in the art, such as the etching method described in Japanese Patent Application Publication No. 2011-154303.

In some embodiments, the methods illustrated in FIGS. 7 and 8 can be combined and modified. For example, in some embodiments, a color-filtering polysiloxane film 140 can be formed on one side of the glass substrate 110, and a polarizing polysiloxane film 320 can be formed on the other side of the glass substrate 110, as illustrated in FIG. 5. Thus, for example, a method of producing such a substrate can include: preparing different colored inks, depositing a black matrix 160 on a top surface 120 of the glass substrate 110, depositing different colored inks into subsets of openings in the black matrix 160, preparing a nano-imprint mask, forming a film of polysilane on a bottom surface 130 of the glass substrate 110, forming a plurality of projections and recesses 330 on the polysilane film on the bottom surface 130 using the nano-imprint mask, treating the substrate 110 at 220° C. in an atmosphere containing oxygen, and depositing a metallic thin film to coat the projections and recesses created by using the nano-imprint mask. Thus, a color-filtering polysiloxane film 140 can be formed on the top surface of the glass substrate 110, and a polarizing polysiloxane film 320 can be harmed on the bottom surface of the glass substrate 110.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition hose enumerated herein, will be apparent to those skilled in the art the foregoing descriptions. Such modifications and variations as are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially. any plural and/or singular terms herein, those having skill in the art can translate from the plural to the singular and/or from the singular to the plural as is appropriate to the context and/or application. The various singular/plural permutations may be expressly set forth herein for sake of clarity.

### Example 1

### Preparing a Strengthened Ultra-Thin Color-Filtering Substrate

Red ink was prepared by dispersing Color Index Pigment Red 19 in an ink base including polysilane. Green ink was prepared by dispersing Pigment Green 7 in an ink base including polysilane. Blue ink was prepared by dispersing Pigment Blue 15 in an ink base including polysilane. The ink for the three colors was injected into an ink-jet drawing system. A film pattern for the three colors was formed on a 100 μm thick ultra-thin glass substrate (manufactured by Nippon Electric Glass (Shiga, Japan)), on which a black matrix had been formed. In the pattern formation process, a pattern of the three colors was deposited on the top surface of the ultra-thin glass substrate, On the bottom surface of the ultra-thin glass substrate, a film of polysilane was formed. The substrate was treated at 220° C. in air.

The resulting ultra-thin substrate exhibited color-filtering functionality. Moreover, the ultra-thin substrate resisted cracking. Thus, heating the polysilane ink and bottom surface film at 220° C. in air provided sufficient internal compressive stress due to the formation of polysiloxane to strengthen the substrate, thereby imparting resistance to cracking.

### Example 2

### Preparing a strengthened ultra-thin polarizing substrate

A nanoimprint mask was prepared by photolithography. A resist material was applied on a substrate, then a latent image was formed on the resist using an ArF immersion exposure machine pattern of 100 nm wide projections and recesses were formed on the substrate. A film of nickel (Ni) was formed over the pattern of projections and recesses by electroforming. The resist material was removed. Thus, a nanoimprint mask with a pattern of 100 nm wide projections and recesses was prepared.

Toluene solution with a 40% weight concentration of methlyphenylpolysilane (manufactured by Osaka Gas Chemicals (Osaka, Japan)) was prepared. The solution was applied to one surface of as 100 μm thick ultra-thin glass substrate (manufactured by Nippon Electric Glass (Shiga, Japan)) by spin coating. The thickness of the film was 200 μm thick. While the polysilane film was still wet, the nanoimprint mask that had previously been prepared was pressed onto the polysilane film using a nanoimprint machine. Thus, a wire grid pattern having 100 nm wide projections and recess was formed on the ultra-thin glass substrate. The solution including polysilane was applied to the other side of the glass substrate.

The substrate was then heated at 220° C. in air. Next metallic film was deposited on the wire grid pattern by means of oblique deposition. The thickness of the metallic film was controlled by the etching, according to the method described in Japanese. Unexamined Patent Application, Publication No. 2011-154303.

The substrate formed was effective in polarizing light, and exhibited excellent strength as evidenced by resistance to cracking. Thus, heating the polysilane film at 20′C in air provided sufficient internal compressive stress due to the formation of polysiloxane to strengthen the substrate, thereby imparting resistance to cracking.

### Example 3

### Making a strengthened ultra-thin glass substrate with both color-filtering and polarizing functionality

A color filter was formed on the top surface of the ultra-thin glass substrate according to the methods described in Example 1. Specifically, red ink was prepared by dispersing Color index Pigment Red 19 in an ink base including polysilane. Green ink was prepared by dispersing. Pigment Green 7 in an ink base including polysilane. Blue ink, was prepared by dispersing Pigment Blue 15 in an ink base including polysilane. The ink for the three colors was injected into an ink-jet drawing system. A film pattern for the three colors was formed on the top surface of a 100 μm thick ultra-thin glass substrate (manufactured by Nippon Electric Glass (Shiga, Japan)), on which as black matrix had been formed. In the pattern formation process, a pattern of the three colors was deposited an the top surface of the ultra-thin glass substrate.

A polarizer was formed on the bottom surface of the ultra-thin glass substrate according to the methods described in Example 2. Specifically, a nanoimprint mask was prepared by photolithography. A resist material was applied on as substrate, then as latent image was formed on the resist using an ArF immersion exposure machine. A pattern of 100 nm wide projections and recesses were formed on the substrate. A film of nickel (Ni) was formed over the pattern of projections and recesses by electroforming. The resist material was removed. Thus, a nanoimprint mask with a pattern of 100 nm wide projections and recesses was prepared.

A toluene solution with a 40% weight concentration of methlyphenylpolysilane (manufactured by Osaka Gas Chemicals (Osaka, Japan)) was prepared. The solution was applied to the bottom surface of as 100 μm thick ultra-thin glass substrate (manufactured by Nippon Electric Glass (Shiga. Japan)) by spin coating. The thickness of the film was 200 μm thick. While the polysilane film was still wet, the nanoimprint mask. that had previously been prepared was pressed onto the polysilane film using a nanoimprint machine. Thus, a wire grid pattern having 100 nm wide projections and recess was formed on the bottom surface of the ultra-thin glass substrate.

The substrate was treated at 220° C. in air. Next a metallic film was deposited on the wire and pattern on the bottom surface of the substrate by means of oblique deposition. The thickness of the metallic film was controlled by the etching, according to the method described in Japanese Unexamined Patent Application, Publication No. 2011-154303.

The resulting ultra-thin substrate exhibited color-filtering functionality due to the color filter on the top surface of the substrate. In addition, the substrate exhibited polarizing functionality due to the polarizer formed on the bottom surface of the substrate. Moreover, the ultra-thin substrate resisted cracking. Thus, heating the polysilane ink at 220° C. in air provided sufficient internal compressive stress due to the formation of polysiloxane to strengthen the substrate, thereby imparting resistance to cracking.

### Example 4

### Making and using a tablet PC having strengthened ultra-thin glass substrates with color-filtering and polarizing functionalities

A first strengthened ultra-thin polarizing substrate was prepared in the same manner as in Example 2. Additionally, an ITO (indium tin oxide) layer was formed on the polarizing polysiloxane film on the first substrate. A second strengthened ultra-thin glass substrate with both color-filtering and polarizing functionality was prepared in the same manner as in Example 3. An ITO layer was formed on the color-filtering polysiloxane film on the second substrate. A spacer was placed between the first and second substrates. A liquid crystal layer was inserted in the space created by the spacer using vacuum technology. Specifically, with reference to FIG. 6, a liquid crystal layer 630 was disposed between the first and second substrates 610, 620, such that the color-filter 650 on the first substrate 610 faced toward the liquid crystal layer 630, and the polarizer 640 on the first substrate 610 faced away from the liquid crystal layer 630. In addition, the polarizer 660 on the second substrate 620 faced away from the liquid crystal layer. A backlight unit 670 was disposed beneath the second substrate. Additional supporting components were built with the device according to methods known in the art to form a tablet PC. The tablet PC device is then used in normal operation while exhibiting color-filtering and polarizing functionality and improved resistance to cracking.

It will be understood by those within the art that, in general, terms used herein, and especially in the appended claims (e.g., bodies of the appended claims) are generally intended as “open” terms (e.g., the term “including” should be interpreted as “Including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite, articles used to introduce claim recitations. In addition, even if a specific number of an introduced claim recitation is explicitly recited, those skilled in the art will recognize that such recitation should be interpreted to mean at least the recited number (e.g., the hare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C. etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the some range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit, being indicated by the following claims.

1-48. (canceled)

49. An apparatus comprising:
a glass substrate comprising, a top surface and a bottom surface and having a thickness of about 100 μm or less;
a color-filtering polysiloxane film formed on the top surface, wherein the color-filtering polysiloxane film comprises:
a black matrix defining a pattern of openings; and
a plurality of colored inks disposed separately within the openings in the black matrix, wherein the black matrix and the plurality of colored inks comprise pigments dispersed in an ink base including polysilane and the polysilane is partially oxidized such that a volume of the ink base is expanded to create internal compressive stress and a fracture strength of the glass substrate is improved; and
a polarizing polysiloxane film formed on the bottom surface of the glass substrate, wherein the polarizing polysiloxane film is in the form of a wire grid pattern defined by a plurality of parallel projections and recesses, the wire grid pattern is configured to polarize light, and the polarizing polysiloxane film is under internal compressive stress such that a fracture strength of the glass substrate is further improved.

50. The apparatus of claim 49, wherein the glass substrate has a thickness of about 30 μm.

51. The apparatus of claim 49, wherein the polarizing polysiloxane film has a thickness of about 20 μm to about 100 μm.

52. The apparatus of claim 49, wherein the color-filtering polysiloxane film has a thickness of about 100 nm to about 5 μm.

53. The apparatus of claim 49, wherein the polarizing polysiloxane film is at least partially coated by a metallic thin film.

54. The apparatus of claim 49, wherein the projections have a height of about 100 nm and a width of about 100 nm, and wherein the recesses have a width of about 100 nm.

55. An apparatus comprising:
a glass substrate comprising a top surface and a bottom surface and haying a thickness of about 100 μm or less;
a color-filtering polysiloxane film formed on the top surface, wherein the color-filtering polysiloxane film comprises:
a black matrix defining a pattern of openings; and
a plurality of colored inks disposed separately within the openings in the black matrix, wherein the black matrix and the plurality of colored inks comprise pigments dispersed in an ink base including polysilane and the polysilane is partially oxidized such that a volume of the ink base is expanded to create internal compressive stress and a fracture strength of the glass substrate is improved; and
a bottom polysiloxane film formed on the bottom surface of the glass substrate.

56. The apparatus of claim 55, wherein the bottom polysiloxane film has a thickness of about 5 μm to about 30 μm.

57. The apparatus of claim 55, wherein the glass substrate has a thickness of about 30 μm.

58. The apparatus of claim 55, wherein the color-filtering polysiloxane film has a thickness of about 100 nm to about 5 μm.

59. The apparatus of claim 55, wherein the plurality of colored inks disposed separately within the openings in the black matrix comprises a GBR three-color pattern.

60. An apparatus comprising:
a glass substrate having a thickness of about 100 μm or less;
a polarizing polysiloxane film formed on a top surface of the glass substrate, wherein the polarizing polysiloxane film is in the form of a wire grid pattern defined by a plurality of parallel projections and recesses, the wire grid pattern is configured to polarize light, and the polarizing polysiloxane film is under internal compressive stress such that a fracture strength of the glass substrate is improved; and
a bottom polysiloxane film formed on a bottom surface of the substrate.

60. The apparatus of claim 60, wherein the polarizing polysiloxane film is at least partially coated by a metallic thin film.

62. The apparatus of claim 61, wherein the metallic film has a thickness in a range from about 20 nm to about 50 nm.

63. The apparatus of claim 60, wherein the polarizing polysiloxane film has as thickness in a range from about 20 μm to about 100 μm.

60. The apparatus of claim 60, wherein the bottom polysiloxane film has a thickness in a range from about 5 μm to about 30 μm.

65. The apparatus of claim 60, wherein the projections have a height of about 100 nm.

66. The apparatus of claim 60, wherein the projections have a width of about 100 nm.

67. The apparatus of claim 60, wherein the recesses have a width of about 100 nm.
